(19) United States
(12) Patent Application Publication
(10) Pub. No.: US 2015/0208319 A1
(43) Pub. Date: Jul. 23, 2015

(54) METHOD AND APPARATUS OF RADIO LINK SELECTION BASED ON DELAY SPREAD

(71) Applicant: ELECTRONICS AND TELECOMMUNICATIONS RESEARCH INSTITUTE, Daejeon (KR)

(72) Inventors: Jong Ho KIM, Daejeon (KR); Myoung Won JUNG, Gongju-si (KR); Young Keun YOON, Cheongju-si (KR)

(21) Appl. No.: 14/591,976

(22) Filed: Jan. 8, 2015

(30) Foreign Application Priority Data
Jan. 20, 2014 (KR) 10-2014-0006895

(51) Int. Cl. H04W 40/12; H04W 72/08

(52) U.S. Cl. CPC H04W 40/12; H04W 72/085

(57) ABSTRACT

The present invention relates to a method and apparatus of radio link selection based on delay spread, the user equipment according to the present invention receives radio signals from neighboring multiple base stations, measures delay spread of the signals received from the multiple neighboring base stations, selects at least one base station among the neighboring base stations based on the delay spread measured, and connects a radio link with the selected at least one base station. According to the present invention, the inter-symbol interference due to delay spread can be decreased, thereby it is available to implement the maximum transmission speed in a given propagation environment.

Priority to Korean patent application number 10-2014-0006895 filed on Jan. 20, 2014, the entire disclosure of which is incorporated by reference herein, is claimed.

### BACKGROUND OF THE INVENTION

1. Field of the Invention

The present invention relates to wireless communications and more particularly to a method and apparatus of radio link selection based on delay spread.

2. Discussion of the Related Art

In the common wireless communication system, in the situation that 1:N radio link is available such as the case that a user equipment is located in the region where the coverage of multiple base stations (or access points; APs) is overlapped, in case that a radio link is selected among the N candidate radio links, the radio link whose signal attenuation is the smallest, that is, whose strength of the received signal is the biggest is selected so as to receive the best signal. However, in case of digital communication systems, there is a problem that the speed of data transmission decreases due to inter-symbol interference generated by delay spread that occurs owing to multiple paths. Although the technique enables more data to be transmitted rapidly in digital communication, the limitation in the data transmission speed is still problematic since the delay spread is generated due to propagation environment such as obstacles or geographic features around the radio link. For example, in the situation that a user equipment is connected to one of the multiple base stations or a user equipment is connected to one of the multiple APs which are spread in space, if the radio link is connected to a base station or AP whose signal strength is simply big, a high speed wireless data transmission technique may not be used due to the inter-symbol interference caused by the delay spread.

### SUMMARY OF THE INVENTION

It is a principal object of the present invention is to provide a method and apparatus of radio link selection based on delay spread.

It is another object of the present invention is to guarantee high transmission speed between a user equipment and a base station considering the delay spread.

It is further object of the present invention is to provide a method and apparatus for configuring a radio link considering the delay spread and signal strength.

According to an aspect of the present invention, a user equipment performing a radio link selection is provided. The user equipment includes a communicating unit configured to receive signals from neighboring base stations, a measuring unit configured to measure delay spread of the signals received from the neighboring base stations, and generates information of the delay spread, and a selecting unit configured to select at least one base station among the neighboring base stations based on the information of the delay spread, and generates request information for radio link connection with the at least one base station, wherein the communicating unit transmits the request information to the selected at least one base station.

According to another aspect of the present invention, a method of radio link selection performed by a user equipment is provided. The method includes receiving signals from neighboring base stations, measuring delay spread of the signals received from the neighboring base stations, and generating information of the delay spread, selecting at least one base station among the neighboring base stations based on the information of the delay spread, generating a request information for radio link connection with the at least one base station, and transmitting the request information to the selected at least one base station.

According to yet another aspect of the present invention, a radio link selection system is provided. The radio link selection system includes a plurality of base stations configured to transmit radio signals, and a user equipment configured to measure delay spread of the signals received from the multiple neighboring base stations, select at least one base station among the neighboring base stations based on the delay spread measured, and connect a radio link with the selected at least one base station.

### BRIEF DESCRIPTION OF THE DRAWINGS

FIGS. 1A and 1B illustrate an example of a network where multiple base stations or multiple APs exist around a user equipment (UE).

FIG. 2 is a flowchart schematically illustrating a conventional method for selecting a radio link based on signal strength.

FIG. 3 is a flowchart illustrating an example of a method for selecting a radio link based on delay spread according to the present invention.

FIG. 4 is an example of block diagram illustrating a UE that performs radio link selection based on delay spread according to the present invention.

### DETAILED DESCRIPTION OF THE INVENTION

The preferred embodiment of the present invention now will be described in detail by reference to the accompanying exemplary drawings in this specification. In attaching reference numerals to elements in each drawing it should be understood that the same reference numeral is used for the same element even if the element is shown in different drawings. In addition, in case that the detailed description for the related known elements and functions is determined to obscure the inventive concept in this specification, the redundant description for the same element will be omitted.

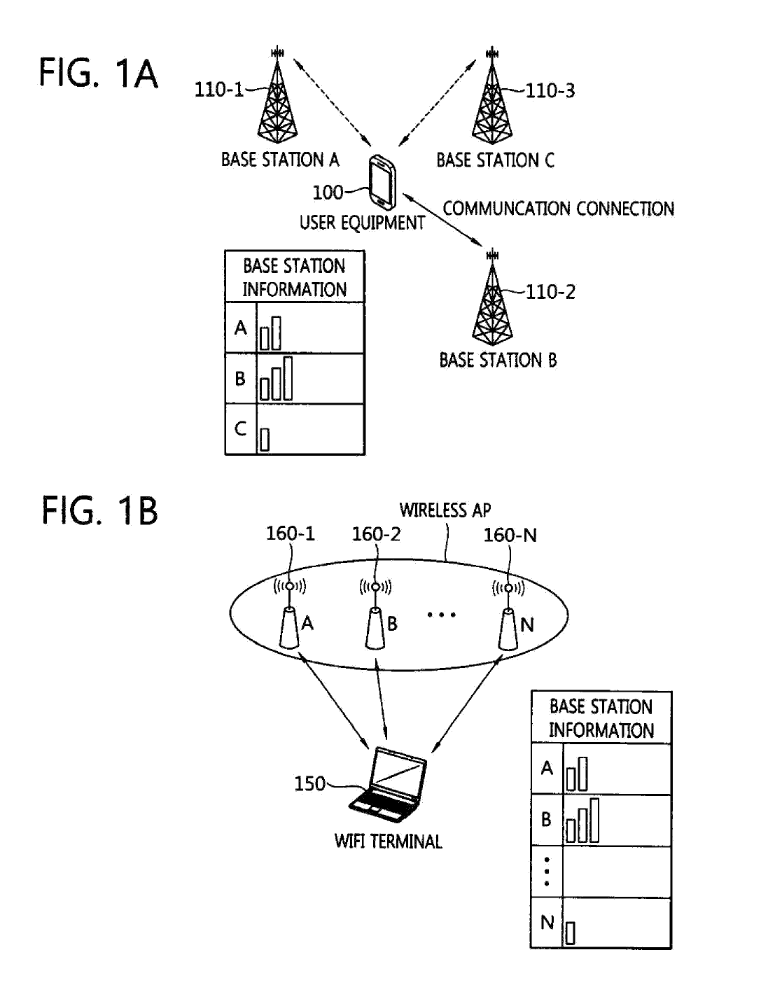

FIGS. 1A and 1B illustrate an example of a network where multiple base stations or multiple APs exist around a user equipment (UE). The UE may be fixed or have mobility, and also referred to as another terms such as a mobile station (MS), a mobile terminal (MT), a user terminal (UT), a subscriber station (SS), a wireless device, a personal digital assistant (PDA), a wireless modem, a handheld device and so on.

Referring to FIG. 1A illustrates the case in which multiple base stations 110 are disposed around a UE 100. For example, the UE 100 may be connected to at least one base station among the neighboring base stations 110 using millimeter wave, and perform a wireless communication. Previously, in this situation, the UE 100 constructed a radio link by selecting the base station whose signal strength received is the biggest among the multiple base stations 110. For example, if the signal strength received from the base station B 110-2 is greater than the signal strength received from the base station A 110-1 and the signal strength received from the base station C 110-3, the UE 100 may be connected to the base station B 110-2 and perform a wireless communication.

FIG. 1B illustrates the case in which a user equipment 150 uses a wireless communication based on WiFi, and multiple APs 160 are disposed therearound. Previously, in this situation, the UE 150 was connected to the AP B 160-2 whose signal strength is the biggest from the point of view of the UE 150, and able to perform a wireless communication.

Meanwhile, although the base station 110 and the AP 160 are separately depicted in FIGS. 1A and 1B, this is just an example for description. Hereinafter, the base station 110 is a concept including the AP 160, and also referred to as another term such as an evolved-NodeB (eNB), a base transceiver system (BTS), a femto nodeB, a home nodeB, a relay and so on.

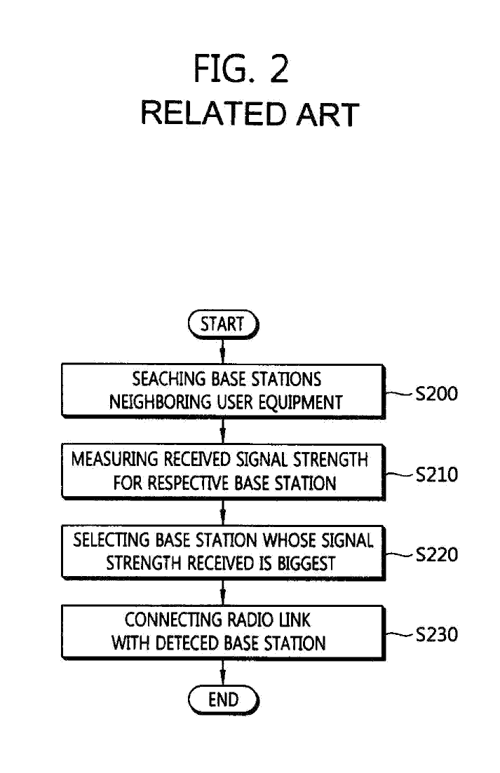

FIG. 2 is a flowchart schematically illustrating a conventional method for selecting a radio link based on signal strength.

Referring to FIG. 2, a UE searches neighboring base stations (step, S200), and measures the signal strength received from the base stations (step, S210).

The UE detects a base station whose signal strength received is the biggest among the base stations (step, S220), and connects a radio link to the detected base station (step S230). Later, the UE may perform a wireless communication with the base station to which the radio link is connected. Even in the situation in which a radio link is connected to a certain base station already, the UE continuously measures the signal strength received from the neighboring base stations, and if a base station that provide the biggest signal strength is changed, the UE may change the radio link to the base station that currently provides the biggest signal strength.

However, the conventional method described above has a problem that the received signal strength is only considered, but the interference occurred by propagation environment is not considered. In order to implement high speed data communication based on the recent digital way, it is required that the radio link selection in which the inter-symbol interference due to delay spread as well as the received signal strength is considered.

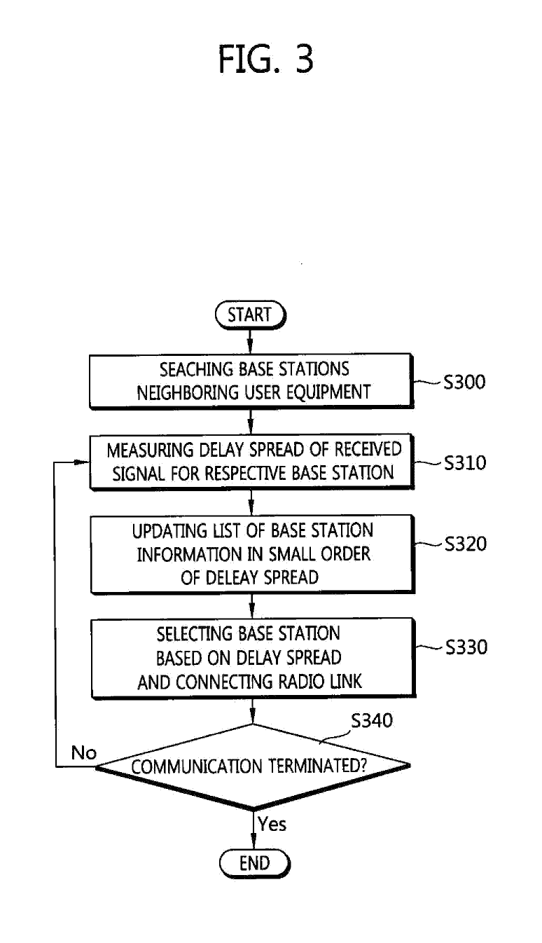

FIG. 3 is a flowchart illustrating an example of a method for selecting a radio link based on delay spread according to the present invention.

Referring to FIG. 3, a UE searches neighboring base stations (step, S300), and measures the delay spread of the signal received from the neighboring base stations (step, S310). It goes without saying that the UE is able to measure the signal strength received from the base stations.

The UE updates the list of base station information in small order of the delay spread based on the information of the delay spread measured (step, S320), and selects at least one base station based on the information of the delay spread and connects a radio link (step, S330). The UE may select the base station whose delay spread is the smallest based on the information of the delay spread and connect the radio link to it. In addition, the UE may select the base station whose delay spread is under a predetermined threshold value and connect the radio link to it. In this case, if there are multiple the base stations whose delay spread are under a predetermined threshold value, the UE may select a base station by further considering the received signal strength, and connect the radio link to the corresponding base station.

Meanwhile, a UE may determine whether a wireless communication is terminated (step, S340). In case that the wireless communication is not terminated, that is, in the situation that a radio link is already connected to a base station, the UE may continuously measure the delay spread of the signal received from neighboring base stations by going back to step, S310, and select a base station again based on the information of the newly measured delay spread and change the radio link. If the delay spread of a base station which is connected to the existing radio link is still the smallest based on the information of the newly measured delay spread, the UE may maintain the radio link with the base station.

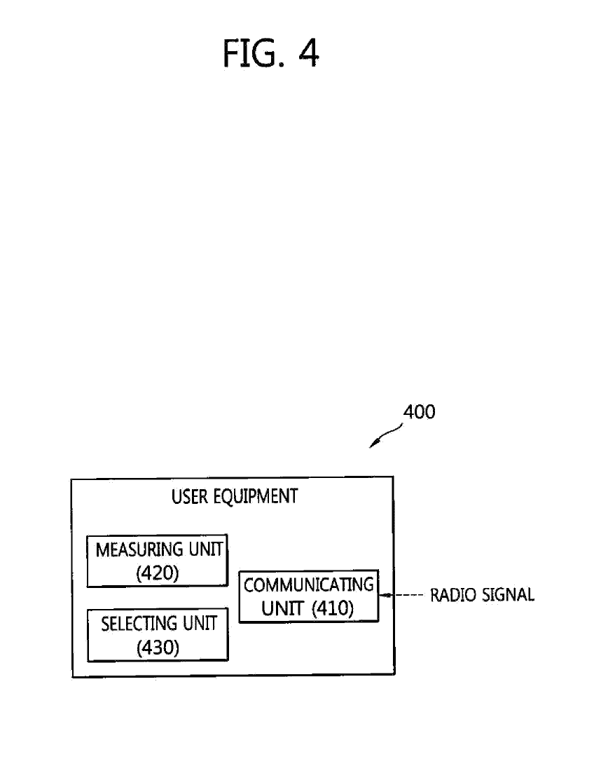

FIG. 4 is an example of block diagram illustrating a UE that performs radio link selection based on delay spread according to the present invention.

Referring to FIG. 4, the UE according to the present invention includes a communicating unit 410, a measuring unit 420 and a selecting unit 430.

The measuring unit 420 measures the delay spread of the signal received from neighboring base stations through the communicating unit 410. That is, the measuring unit 420 measures the delay spread for each of the neighboring base stations, and generates the information of the delay spread. The measuring unit 420 may further measure the signal strength received from the neighboring base stations.

The selecting unit 430 selects at least one base station based on the information of the delay spread. As an example, the selecting unit 430 may select the base station whose delay spread is the smallest based on the information of the delay spread. As another example, the selecting unit 430 may select at least one base station whose delay spread is under a predetermined threshold value and connects a radio link to it. In this case, if there are multiple base stations whose delay spread are under a predetermined threshold value, the UE may select at least one base station by further considering the received signal strength.

The selecting unit 430 transmits request information for connecting a radio link with the at least one base station to the selected at least one base station through the communicating unit 410.

So far, the present invention has been described by reference to the drawings and the embodiments as an example, and it should be understood by those skilled in the art, however, that the present invention can be modified or changed in various ways without departing from the technical principles and scope. Accordingly, the embodiment disclosed in the present invention is not intended to limit the scope of the inventive concept of the present invention, but to describe, and the scope of the inventive concept of the present invention is not, limited to the embodiment. The scope of the present invention should be interpreted by the claims below, and it should be interpreted that all inventive concept within the equivalent scope is included in the scope of the present invention.

What is claimed is:

1. A user equipment performing a radio link selection, comprising:
a communicating unit configured to receive signals from neighboring base stations;
a measuring unit configured to measure delay spread of the signals received from the neighboring base stations, and generates information of the delay spread; and
a selecting unit configured to select at least one base station among the neighboring base stations based on the information of the delay spread, and generates request information for radio link connection with the at least one base station,
wherein the communicating unit transmits the request information to the selected at least one base station.

2. The user equipment of claim 1, wherein the selecting unit selects a base station whose delay spread is the smallest among the neighboring base stations based on the information of the delay spread.

3. The user equipment of claim 1,
wherein the measuring unit measures signal strength of the signals received from the neighboring base stations, and
wherein the selecting unit selects at least one base station among the neighboring base stations based on the information of the delay spread and the information of the received signal strength.

4. The user equipment of claim 3, wherein the selecting unit selects at least one base station whose delay spread is under a predetermined threshold value among the neighboring base stations based on the information of the delay spread.

5. The user equipment of claim 4, wherein the selecting unit, if multiple base stations whose delay spread are under a predetermined threshold value among the neighboring base stations, selects a base station whose signal strength received is the biggest among the multiple neighboring base stations.

6. The user equipment of claim 1,
wherein the measuring unit, even if a radio link is connected between the user equipment and at least one base station, measures the delay spread of signals received from the neighboring base stations continuously, and updates the information of the delay spread, and
wherein the selecting unit selects again at least one base station for the radio link connection based on the updated information of the delay spread.

7. A method of radio link selection performed by a user equipment, comprising:
receiving signals from neighboring base stations;
measuring delay spread of the signals received from the neighboring base stations, and generating information of the delay spread;
selecting at least one base station among the neighboring base stations based on the information of the delay spread;
generating a request information for radio link connection with the at least one base station; and
transmitting the request information to the selected at least one base station.

8. The method of radio link selection of claim 7, wherein the selected at least one base station is a base station whose delay spread is the smallest among the neighboring base stations.

9. The method of radio link selection of claim 7, wherein the selected at least one base station is a base station whose delay spread is under a predetermined threshold value among the neighboring base stations.

10. The method of radio link selection of claim 7, further comprising measuring signal strength of the signals received from the neighboring base stations, wherein the selected at least one base station is further based on the information of the received signal strength.

11. The method of radio link selection of claim 10, wherein at least one base station, if multiple base stations whose delay spread are under a predetermined threshold value among the neighboring base stations, is selected as the base station whose signal strength received is the biggest among the multiple neighboring base stations.

12. The method of radio link selection of claim 7, further comprising:
connecting a radio link with at least one base station;
measuring delay spread of signals received from the neighboring base stations continuously, and updating the information of the delay spread; and
selecting again at least one base station for the radio link connection based on the updated information of the delay spread.

13. The method of radio link selection of claim 12, further comprising:
updating a radio link with the reselected at least one base station.

14. A radio link selection system, comprising:
a plurality of base stations configured to transmit radio signals; and
a user equipment configured to measure delay spread of the signals received from the multiple neighboring base stations, select at least one base station among the neighboring base stations based on the delay spread measured, and connect a radio link with the selected at least one base station.

15. The radio link selection system of claim 14, wherein the user equipment selects a base station whose delay spread is the smallest among the neighboring base stations.

16. The radio link selection system of claim 14, wherein the user equipment selects at least one base station whose delay spread is under a predetermined threshold value among the neighboring base stations.

17. The radio link selection system of claim 14, wherein the user equipment measures signal strength of the signals received from the respective multiple base stations, and selects at least one base station further based on the information of the received signal strength.

18. The radio link selection system of claim 17, wherein the user equipment, if the number of base station whose delay spread are under a predetermined threshold value among the neighboring base stations is two or more, selects a base station whose signal strength received is the biggest among the two or more base stations.

19. The radio link selection system of claim 14,
wherein the user equipment connects a radio link with at least one base station, and
wherein the user equipment measures the delay spread of signals received from the neighboring base stations continuously, and selects again at least one base station for the radio link connection based on the delay spread continuously measured.

20. The radio link selection system of claim 19, wherein the user equipment updates a radio link with the reselected at least one base station.
